(19) United States
(12) Patent Application Publication
(10) Pub. No.: US 2010/0289927 A1
(43) Pub. Date: Nov. 18, 2010

(54) IMAGE CAPTURING ELECTRONIC DEVICE

(76) Inventor: Yu-Bing Chen, Hangzhou City (CN)

Correspondence Address: NORTH AMERICA INTELLECTUAL PROPERTY CORPORATION, P.O. BOX 506, MERRIFIELD, VA, 22116, US

(21) Appl. No.: 12/635,678

(22) Filed: Dec. 10, 2009

(30) Foreign Application Priority Data
May 12, 2009 (CN) 200910136381.5

(51) Int. Cl. H04N 5/217; H04N 5/228; H04N 7/12

(52) U.S. Cl. 348/241; 348/222.1; 375/240.25; 348/E05.078; 375/E07.027; 348/E05.031

(57) ABSTRACT

An image capturing electronic device is utilized for improving the quality of the recorded video data affected by initializing the photograph lens. The image capturing electronic device includes a video capturing module, a video effect module, two Smart Tee modules, a timestamp module, a snapshot module, an AVI de-compressor module, a VMR module, an audio capture module, an ACM wrapping module, a media pipe module, and an encoder. The image capturing electronic device utilizes the snapshot module and the media pipe module to control the flow of video/audio data entering the encoder for switching between the preview mode and the record mode. Therefore, the image capturing electronic device does not require initializing the photograph lens when switching modes, consequently preventing the initialization of the photograph lens from impacting the quality of recorded video data.

### BACKGROUND OF THE INVENTION

1. Field of the Invention

The present invention relates to an image capturing electronic device with the preview mode, and more particularly, to an image capturing electronic device with real-time switching between the preview mode and the record mode.

2. Description of the Prior Art

Please refer to FIG. 1, which is a diagram illustrating a filter graph of a conventional image capturing electronic device 100 in the preview mode. In the preview mode, the image capturing electronic device 100 comprises a video capturing module 110, a Smart Tee module 111, a timestamp module 112, a snapshot module 113, a null rendering module 114, an AVI de-compressing module 115, and a video mixing renderer (VMR) module 116. The video capturing module 110 captures a plurality of images for generating a video data D. The Smart Tee module 111 fans out the video data D to be video data D₁ and D₂. That is, the video data D₁ and D₂ are the same as the video data D. The Smart Tee module 111 transmits the video data D₁ and D₂ to the timestamp module 112 and the AVI de-compressing module 115, respectively. The timestamp module 112 transmits the video data D₁ to the null rendering module 114 through the snapshot module 113. In the preview mode, the null rendering module 114 abandons the video data D₁. The AVI de-compressing module 115 converts the format of the video data D₂ and the converted video data is the display data D_{D}, which can be displayed by the VMR module 116. In this way, in the preview mode, the image capturing electronic device 100 only displays the video data D and does not store the video data D.

Please refer to FIG. 2, which is a diagram illustrating a conventional image capturing electronic device 100 switching to the record mode. At the time, the image capturing electronic device 100 comprises a video capturing module 110, two Smart Tee modules 111 and 121, a snapshot module 113, an AVI de-compressing module 115, a VMR module 116, an audio capturing module 120, an ACM wrapping module 122, and an encoder 130. The video capturing module 110 captures a plurality of images for generating a video data D. The Smart Tee module 111 fans out the video data D to be the video data D₁ and D₂. That is, the video data D₁ and D₂ are the same as the video data D. The Smart Tee module 111 transmits the video data D₁ and D₂ to the snapshot module 113 and the AVI de-compressing module 115, respectively. The snapshot module 113 transmits the video data D₁ to the encoder 130. The AVI de-compressing module 115 converts the format of the video data D₂ and the converted video data is the video data D_{D}, which can be displayed by the VMR module 116. The audio capturing module 120 captures sounds corresponding to the plurality of the images for generating an acoustic data S. The Smart Tee module 121 receives the acoustic data S and transmits to the ACM wrapping module 122. The ACM wrapping module 122 encodes the acoustic data S and the encoded acoustic data is the audio data S_{C}. The encoder 130 encodes the video data D₁ and the audio data S_{C} and accordingly generates a media file, e.g. Windows Media Video (WMV) file. In this way, in the record mode, the image capturing electronic device 100 displays the video data D while encoding the video data and the audio data for recording the image and the acoustic data in one file.

Please refer to FIG. 1 and FIG. 2 together. When the image capturing electronic device 100 switches from the preview mode to the record mode, the image capturing electronic device 100 removes modules unnecessary to the record mode, e.g. the null rendering module 114, and adds modules required by the record mode, e.g. the audio capturing module 120, the ACM wrapping module 122, and the encoder 130. However, a photograph lens of the video capturing module 120 will be initialized when the mode of the image capturing electronic device 100 switches. During the initialization of the photograph lens, some adjustments are required, e.g. auto-focusing or the brightness of the captured image. Therefore, during the initialization of the photograph lens, the quality of the video recorded by the image capturing electronic device 100 is decreased. Generally, such problem is solved by delaying the time that the image capturing electronic device 100 starts to record. In other words, the video data during the initialization of the photograph lens is abandoned. However, there are two drawbacks of the delaying video recording:

1. The types of the photograph lens are various, and the initial period required by each kind of the photograph lens is different from others; in other words, the delay length of delaying video recording is not standardized; and

2. The video data abandoned by delaying video recording possibly comprises important content.

Therefore, when the image capturing electronic device 100 switches from the preview mode to the record mode, the initialization of the photograph lens affects the quality of the video data recorded by the image capturing electronic device 100, causing great inconvenience. Furthermore, when the image capturing electronic device 100 starts to record, the video data D₁ and the audio data S_{C} are synchronized by their own timestamps, but the timestamp of the video data D₁ is tagged to the video data D₁ when the photograph lens outputs video and errors are frequently generated on the timestamp of the video data D₁ under the situation that the image capturing electronic device 100 operates in the preview mode for a long time, which causes the un-synchronization between the video data and the audio data (the video data falls behind the audio data).

### SUMMARY OF THE INVENTION

The present invention provides an image capturing electronic device with preview mode and capable of recording a plurality of images. The plurality of the images have video data and audio data. The image capturing electronic device comprises a video capturing module for generating the video data, a snapshot module for receiving the video data, a VMR module for displaying the video data, an audio capturing module for capturing sounds corresponding to the plurality of the images for generating an acoustic data when the plurality of the images are recorded by the image capturing electronic device, a media pipe module for receiving the acoustic data, an ACM wrapping module for converting the acoustic data to the audio data, and an encoder for encoding the video data and the audio data and accordingly generating a media file. In the preview mode, the snapshot module does not output the video data to the encoder, the media pipe module does not output the acoustic data to the ACM wrapping module, and the video data can be previewed through the VMR module. In record mode, the snapshot module outputs the video data to the encoder and the media pipe module outputs the acoustic data to the ACM wrapping module for allowing the ACM wrapping module outputting the audio data to the encoder, so as to generate the media file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a filter graph of a conventional image capturing electronic device in the preview mode.

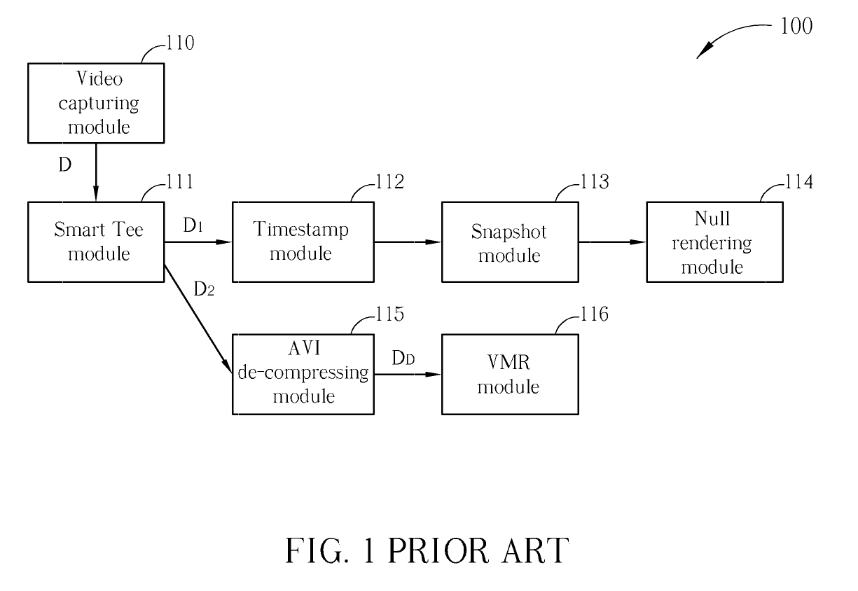

FIG. 2 is a diagram illustrating a conventional image capturing electronic device switching to the record mode.

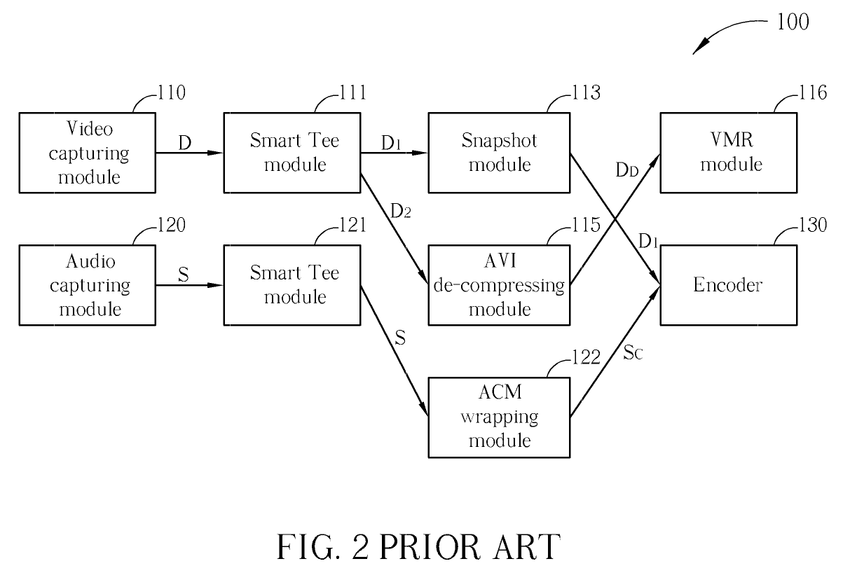

FIG. 3 is a diagram illustrating an image capturing electronic device of the present invention in the preview mode and the record mode.

FIG. 4 is a diagram illustrating the video effect module of FIG. 3.

FIG. 5 is a diagram illustrating a synthesizing module of the present invention.

FIG. 6 is a diagram illustrating the media stream module synthesizing images.

### DETAILED DESCRIPTION

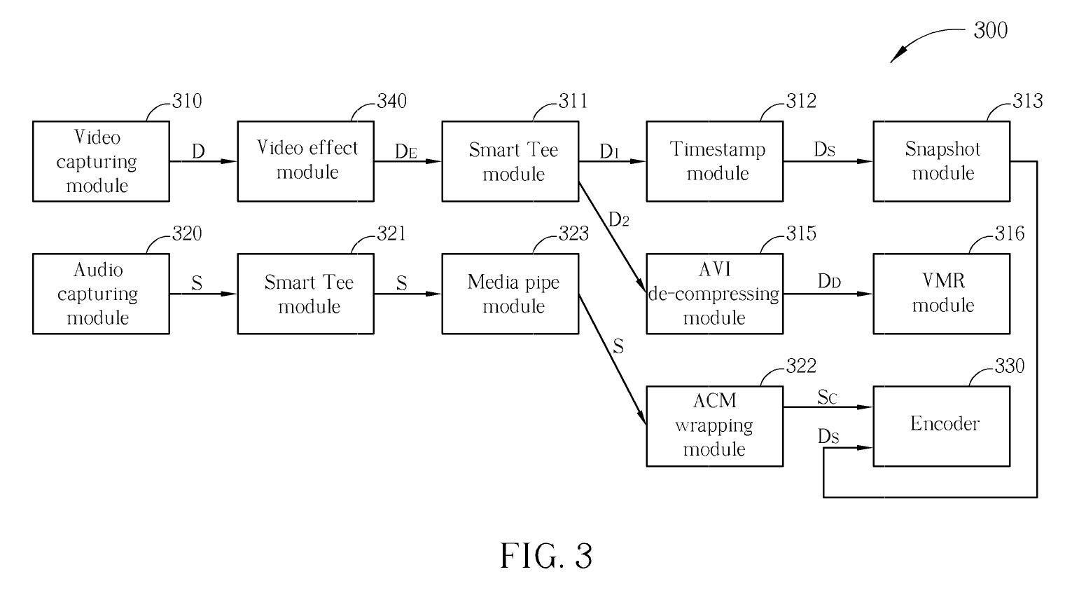

Please refer to FIG. 3, which is a diagram illustrating an image capturing electronic device 300 of the present invention in the preview mode and the record mode. The image capturing electronic device 300 comprises a video capturing module 310, a video effect module 340, two Smart Tee modules 311 and 321, a timestamp module 312, a snapshot module 313, an AVI de-compressing module 315, a VMR module 316, an audio capturing module 320, an ACM wrapping module 322, a media pipe module 323, and an encoder 330. The operation principles of the image capturing electronic device 300 will be explained as follows.

First, the video capturing module 310 captures a plurality of images for generates a video data D. The video effect module 340 applies a video effect onto the video data D and accordingly outputs the video data D_{E} with the applied video effect to the Smart Tee module 311. The Smart Tee module 311 fans out the video data D_{E} to be the video data D₁ and D_{2.} That is, the video data D₁ and D₂ are the same as the video data D_{E}. The Smart Tee module 311 transmits the video data D₁ and D₂ to the timestamp module 312 and the AVI de-compressing module 315, respectively. The timestamp module 312 corrects the timestamp of the video data D₁, and accordingly outputs the video data D_{S} with the corrected timestamp to the snapshot module 313. In the present embodiment, the timestamp module 312 calculates the period of the previous frame (comprising a number of images where the number is decided by the frame rate) and uses the result as the period of the current frame to adjust the display time (timestamp) of the current frame. In this way, the current frame with the adjusted timestamp is synchronized with the corresponding audio data. The snapshot module 313 controls if the video data D_{S} is outputted to the encoder 330 or not. The AVI de-compressing module 315 converts the format of the video data D₂ and the converted video data is the display data D_{D}, which can be displayed by the VMR module 316. The audio capturing module 320 captures sounds corresponding to the plurality of the images for generating an acoustic data S. The Smart Tee module 321 receives the acoustic data S and transmits to the media pipe module 323. The media pipe module 323 controls if the acoustic data S is outputted to the ACM wrapping module 322. The ACM wrapping module 322 encodes the acoustic data S and the encoded acoustic data is the audio data S_{C}. The encoder 330 encodes the video data D_{S} and the audio data S_{C} and accordingly generates a media file, e.g. Windows Media Video (WMV) file.

The image capturing electronic device 300, compared to the image capturing electronic device 100, utilizes the snapshot module 313 and the media pipe module 323 as the switch for controlling the flow of the video data D_{S} and the audio data S_{C} entering the encoder 330. More particularly, when the image capturing electronic device 300 operates in the preview mode, the snapshot module 313 stops outputting the video data D_{S} to the encoder 330 and abandons the video data D_{S}, and the media pipe module 323 stops outputting the audio data S_{C} to the ACM wrapping module 322; when the image capturing electronic device 300 operates in the record mode, the snapshot module 313 outputs the video data D_{S} to the encoder 330, and the media pipe module 323 outputs the audio data S_{C} to the ACM wrapping module 322. In other words, the image capturing electronic device 300 utilizes the snapshot module 313 and the media pipe module 323 for switching the preview mode and the record mode. In this way, when the image capturing electronic device 300 switches its operating mode, the related modules do not have to be updated as well. That is, the photograph lens of the video capturing module 310 does not have to be initialized when the operating mode of the image capturing electronic device 300 is changed. Therefore, the image capturing electronic device 300 can real-timely switches from the preview mode to the record mode without affecting the quality of the video recording.

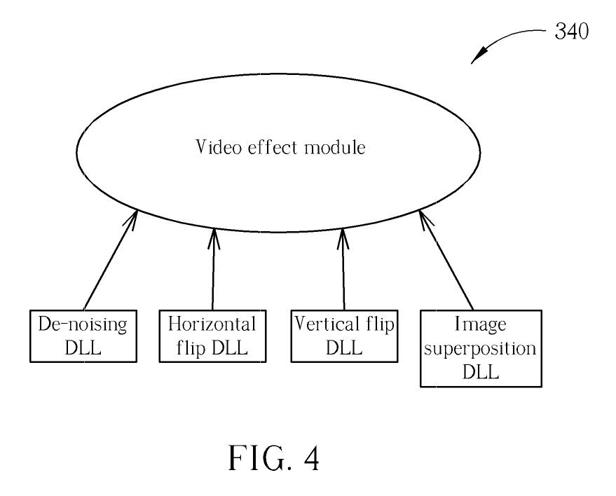

Please refer to FIG. 4, which is a diagram illustrating the video effect module 340 of FIG. 3. The video effect module 340 applies a video effect onto the video data. The video effect may be de-noising, horizontal flip, vertical flip, and image superposition. The video effect is employed with a predetermined color space, e.g. YUY2. Since each kind of the video effect is achieved with an independent Dynamic Linked Library (DLL), the video effect module 340 can load the corresponding DLLs as desired.

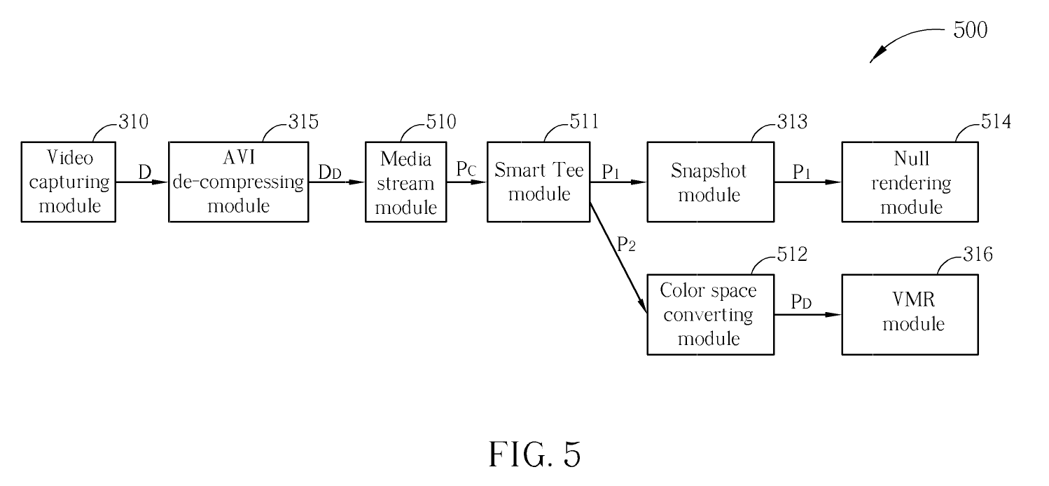

It is noticeable that the image capturing electronic device 300 is only illustrated as one exemplary embodiment, and the modifications may be made by those skilled in the art. For example, the video capturing module 310 can further comprises a synthesizing module for combining the video data captured by the video capturing module 310 with a predetermined image and accordingly generating a synthesized image. Please refer to FIG. 4 and FIG. 5 together. FIG. 5 is a diagram illustrating a synthesizing module 500 of the present invention. As shown in FIG. 5, the synthesizing module 500 can be realized with the video capturing module 310, the AVI de-compressing module 315, the snapshot module 313, and the VMR module 316, and further a media stream module 510, a Smart Tee module 511, a color space converting module 512, and a null rendering module 514. The video capturing module 310 captures a plurality of images for generating a video data D. The AVI de-compressing module 315 converts the video data D to be the display data D_{D}. The media stream module 510 captures an image data from the display data D_{D} and combines the captured image data with a predetermined image for generating a synthesized data P_{C}. For example, the captured image data may be data for a human face, and the predetermined image may be data for a predetermined human face. The Smart Tee module 511 fans out the synthesized data P_{C} to be synthesized data P₁ and synthesized data P₂. The synthesized data P₁ and the synthesized data P₂ are the same as the synthesized data P_{C}. The Smart Tee module 511 transmits the synthesized data P₁ and P₂ to the snapshot module 313 and the color space converting module 512, respectively. The snapshot module 313 transmits the synthesized data P₁ to the null rendering module 514 in the record mode. The null rendering module 514 abandons the synthesized data P₁. The color space converting module 512 converts the color space of the synthesized data P₂ and accordingly outputs a converted synthesized data P_{D} to the VMR module 316. The VMR module 316 displays the converted synthesized data P_{D}.

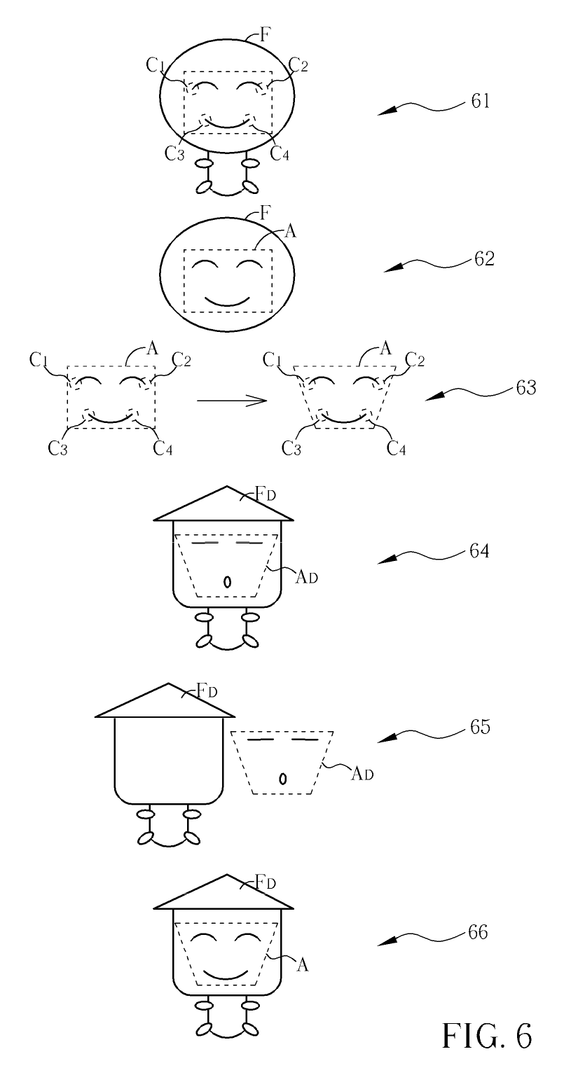

Please refer to FIG. 6. FIG. 6 is a diagram illustrating the media stream module 510 synthesizing images. The operation flow of the media stream module 510 will be described as the following steps:

Step 61: Trace a plurality of character points C₁˜Cₙ of human face data F;

Step 62: Cut an area A from the human face data F;

Step 63: Adjust the boundary of the cut area A according to the character points C₁˜Cₙ;

Step 64: Calculate a corresponding area A_{D} of predetermined human face data F_{D} according to the cut area A;

Step 65: Mask the corresponding area A_{D};

Step 66: Combine the cut area A and the predetermined human face data F_{D}.

In step 61, the character points C₁˜Cₙ can be obtained from the human face data F. The character points C₁˜Cₙ may be the right corner of the right eye, the left corner of the left eye, and the right and the left corners of the mouth. The character points C₁˜Cₙ approximately describe the shape information of the human face F, e.g. the human face tilt angle and body shape of the human face data F. The number of the character points C₁˜Cₙ can be decided as desired.

In step 62, the area A is obtained from a synthesized parameter fed back from the human face data F. If the cut area A is too small, it possibly causes the synthesized image more artificial; if the cut area A is too big, it possibly causes overloading of the system with the related calculation. Thus, the media stream module 510 decides the synthesized parameters of the human face data F of the current frame according to the synthesized parameters of the human face data of the previous frame, so as to optimize the cut area A.

In step 63, the cut area A is adjusted according to the shape information of the human face data F described by traced character points C₁˜Cₙ.

In step 64, the media stream module 510 calculates a corresponding area A_{D} of predetermined human face data F_{D} according to the cut area A, and in step 65, masks the area A_{D} of the human face data F_{D}. Finally, in step 66, the cut area A is combined with the masked predetermined human face data F_{D}.

To sum up, the present invention provides an image capturing electronic device with real-time switching between the preview mode and the record mode, for preventing the impact from the initialization of the photograph lens caused by mode changing to the quality of the recorded video data.

Those skilled in the art will readily observe that numerous modifications and alterations of the device and method may be made while retaining the teachings of the invention.

what is claimed is:

1. An image capturing electronic device with preview mode and capable of recording a plurality of images having video data and audio data, the image capturing electronic device comprising:
a video capturing module for generating the video data;
a snapshot module for receiving the video data;
a Video Mixing Renderer (VMR) module for displaying the video data;
an audio capturing module for capturing sounds corresponding to the plurality of the images for generating an acoustic data when the plurality of the images are recorded by the image capturing electronic device;
a media pipe module for receiving the acoustic data;
an ACM wrapping module for converting the acoustic data to the audio data; and
an encoder for encoding the video data and the audio data and accordingly generating a media file;
wherein in the preview mode, the snapshot module does not output the video data to the encoder, the media pipe module does not output the acoustic data to the ACM wrapping module, and the video data can be previewed through the VMR module;
wherein in record mode, the snapshot module outputs the video data to the encoder and the media pipe module outputs the acoustic data to the ACM wrapping module for allowing the ACM wrapping module outputting the audio data to the encoder, so as to generate the media file.

2. The image capturing electronic device of claim 1, further comprising:
an AVI de-compressing module for converting the video data;
a timestamp module for correcting a timestamp of the video data according to a period of a previous frame, and outputting the corrected video data to the snapshot module;
a first Smart Tee module for receiving the video data generated by the video capturing module and fanning out the received video data to the timestamp module and the AVI de-compressing module respectively; and
a second Smart Tee module for receiving the acoustic data generated by the ACM wrapping module and outputting the received acoustic data to the media pipe module.

3. The image capturing electronic device of claim 2, further comprising:
a video effect module for applying a video effect onto the video data generated by the video capturing module and accordingly outputting the video with the applied vide effect to the first Smart Tee module.

4. The image capturing electronic device of claim 3, wherein the video effect may be de-noising, horizontal flip, vertical flip, or image superposition.

5. The image capturing electronic device of claim 4, wherein the video effect module comprises a Dynamic Linked Library (DLL) for de-noising, horizontal flip, vertical flip, or image superposition.

6. The image capturing electronic device of claim 2, further comprising:
a media stream module for capturing an image data from the video data and combining the captured image data with a predetermined image so as to generate a synthesized data;
a color space converting module for converting color space of the synthesized data and outputting the converted synthesized data to the VMR module; and
a third Smart Tee module for receiving the synthesized data and outputting the received synthesized data to the color space converting module and the snapshot module.

7. The image capturing electronic device of claim 6, wherein the image data is human face data, and the predetermined image is predetermined human face data.

8. The image capturing electronic device of claim 1, wherein when the image capturing electronic device operates in the preview mode, the snapshot module abandons the video data.
